(19) United States
(12) Patent Application Publication
(10) Pub. No.: US 2009/0249626 A1
(43) Pub. Date: Oct. 8, 2009

(54) Machining method

(75) Inventor: Ruediger Boehm, Untermerzbach-Memmelsdorf (DE)

Correspondence Address: GIFFORD, KRASS, SPRINKLE,ANDERSON & CITKOWSKI, P.C, PO BOX 7021, TROY, MI, 48007-7021, US

(73) Assignee: Roesler Holding GmbH & Co. KG, Bad Staffelstein (DE)

(21) Appl. No.: 12/420,453

(22) Filed: Apr. 8, 2009

(30) Foreign Application Priority Data
Apr. 8, 2008 (DE) 10 2008 017 841.1

(51) Int. Cl. B21D 53/30; B23Q 1/44; B24B 1/00

(52) U.S. Cl. 29/894.35; 29/802; 451/51

(57) ABSTRACT

In a method for the machining of a rotationally symmetrical workpiece, said workpiece is dipped into a container filled with processing means and is moved relative to the processing means container. In this respect, the workpiece is simultaneously rotated about its central axis by separate drives and its central axis is moved along a closed orbit in the container.

The present invention relates to a method for the machining of workpieces, in particular of rotationally symmetrical workpieces, e.g. vehicle wheel rims.

It is the object of the invention to provide a method and an apparatus for the machining of workpieces with which an improved influencing of different geometries of the workpiece is possible during the machining process.

This object is satisfied by the features of the independent claims.

Using the method in accordance with the invention, the workpiece is simultaneously rotated about its own central vertical axis by a first drive motor; its central axis is moved along an orbital movement along a closed orbit about a rotating vertical axis by a second drive motor; and this vertical axis is rotated about a stationary vertical axis of rotation with the help of a third drive motor. Due to the connection of three separate drive motors, they can be controlled separately and a clear improvement and standardization of the material removal can be achieved. Since the workpiece is not only moved about its own central vertical axis, but also about an orbital path, which is in turn rotated about a stationary vertical axis of rotation, a best possible standardization of the grinding result can be achieved. Much improved results were able to be achieved in contrast to grinding processes in which the workpiece is admittedly rotated about three axes of rotation parallel to one another, but not about its own central axis.

Using the apparatus in accordance with the invention, the orbital movement and the rotational movement of the workpiece is effected with the help of two separate drive motors, whereby these two drives can be regulated independently separately from one another and are no longer fixedly coupled. Much improved machining results can hereby be achieved and a considerable improvement and standardization of the material removal can be achieved at the rim surface, from the inside to the outside, and an ideal throughflow behavior as well as a uniform material removal can be achieved from the center of the workpiece up to its outer periphery.

Advantageous embodiments of the invention are described in the description, in the drawing and in the dependent claims.

In accordance with a first advantageous embodiment, a plurality of workpieces can be dipped into the container and can be moved relative to the container, with all the workpieces being rotated about their own central vertical axes, about the rotating vertical axis and about the stationary vertical axis of rotation. In this process, the advantage results that possible machining shadows are minimized since each workpiece is also rotated about its own central axis and thus no part of the workpiece circulates on a circular path on which the part is always directed to the center of this circular path.

In accordance with a further advantageous embodiment, the workpiece can be moved in a direction of rotation along the closed orbit, with the workpiece being moved about its own central axis in the direction of rotation opposite thereto. Very good results have been achieved, in particular by variation of the respective speeds of rotation, by such an opposite sense of direction of the orbital movement, on the one hand, and of the rotational movement, on the other hand. It is therefore advantageous if the speed of the first drive motor is varied independently of the speed of the second drive motor.

In accordance with a further advantageous embodiment, none of the drive motors is exposed to a rotational or orbital movement. This contributes to a long service life of the apparatus since the two drive motors only have to be exposed to the oscillation movement which, however, takes place at a comparatively low speed.

In accordance with a further advantageous embodiment, a wobble movement can additionally be applied to the workpiece to increase the relative movement between the processing means and the workpiece even further.

Good results have also been able to be achieved in that the maximum speed of the rotational movement and of the orbital movement is selected to be lower than approximately 150 r.p.m.

In accordance with an advantageous embodiment of the apparatus, the two drive motors are mounted on a component which is either stationary, for example when the processing means container is oscillated, or which can be oscillated by an oscillation device. The advantage likewise results in this embodiment that the two electric motors are not subject to any fast rotational movements, but are rather only subject to a comparatively slow oscillation movement.

In accordance with a further advantageous embodiment, the orbital drive has a component which is rotatably driven by a drive motor and at which the chuck is fastened eccentrically and rotatably. In this manner, the chuck which circulates about the orbital track can be rotated about its own axis using a drive motor which does not itself circulate along the orbital track, but rather remains stationary—in comparison with the movement of the workpiece. It can be advantageous in this respect when the rotation device has a shaft which is rotatably driven by the other drive motor, which extends through the component and which is in rotational communication with the chuck. A cost-effective solution is hereby created which manages with only a few components and nevertheless ensures the desired decoupling of the different movements.

In accordance with a further advantageous embodiment, a third drive motor can be provided with which the vertical axis is rotatable about a stationary vertical axis of rotation so that the workpiece rotates about its own central axis, on the one hand, and the workpiece circulates on an orbital track and rotates about the stationary vertical axis of rotation, on the other hand.

In accordance with a further advantageous embodiment, the rotation device can have a plurality of chucks which can be set into rotation about their own central axes either via a common transmission, for example a planetary transmission, or via a respective drive of their own. In this embodiment, the chucks are arranged coaxially to one another and are rotated about their own axes of rotation, on the one hand, about the rotating axis of rotation, on the other hand, and finally also about the stationary axis of rotation, whereby best machining results are achieved. Even if in the above the movement of the workpiece is preferably described relative to the processing means container, it is always assumed that it generally of no significance for the invention whether the described movements are achieved by movement of the workpiece or, alternatively, by movement of the container. In the embodiment described, however, it is not the container which is moved, but exclusively the rim since this requires a lower effort with respect to the apparatus and to the construction.

It must additionally be noted that the method in accordance with the invention is generally suitable for all workpieces and in particular also for rotationally symmetrical workpieces. All type of rims or wheels can be considered as rims, i.e. rims for automobiles, trucks or motorcycles in all sizes and variations. The machining can be a deburring, descaling, rounding, grinding, polishing or the like.

The present invention will be described in the following purely by way of example with reference to an advantageous embodiment and to the enclosed drawing.

There are shown:

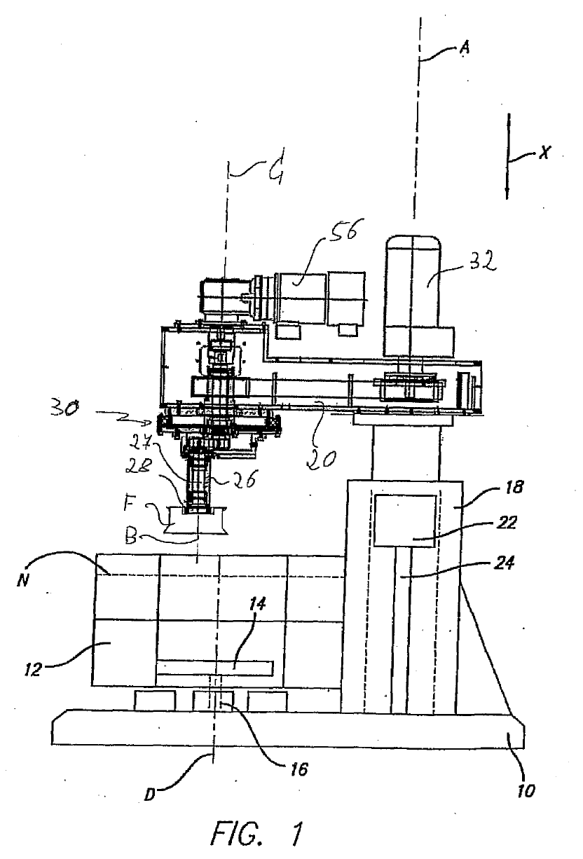

FIG. 1 a side view of a first embodiment of a machining apparatus;

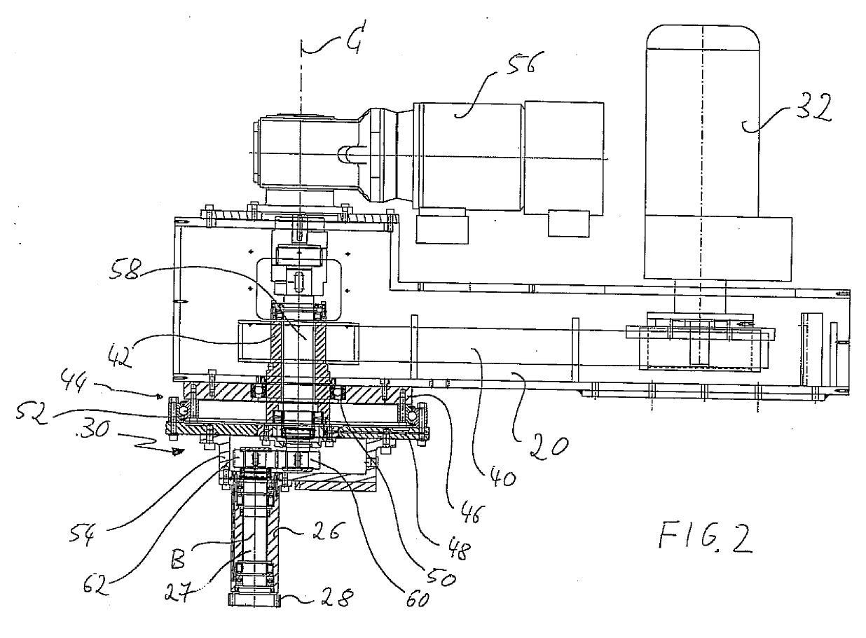

FIG. 2 an enlarged representation of a part of the machining apparatus of FIG. 1; and

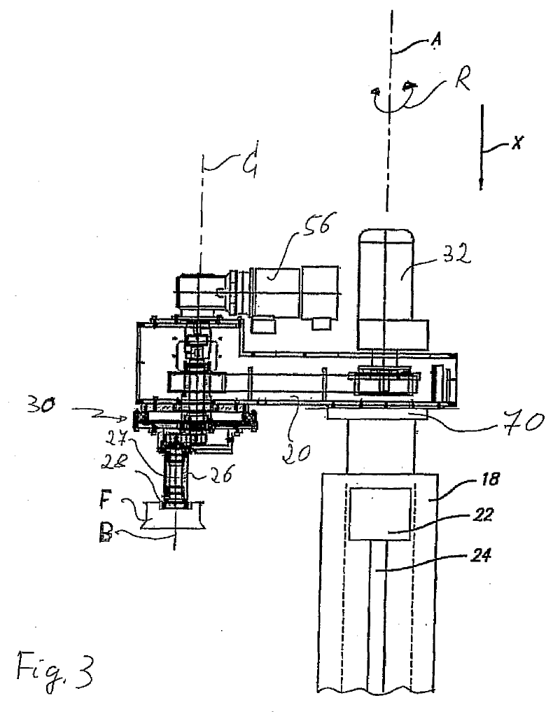

FIG. 3 a second embodiment of a machining apparatus.

The machining apparatus shown in FIG. 1 has a base frame 10 on which a processing means container 12 is arranged. The processing means container 12 is round and upwardly open in the embodiment shown, but can also be made in trough form or in tub form. The processing means container 12 is not in any fixed communication with the base frame 10 and can thus be replaced without problem by forklift trucks. A vibration drive can additionally be provided to increase the processing means movement. Furthermore, various inflow and outflow possibilities are provided at the processing means container 12 to add or remove water means and/or treatment means (compounds) continuously. In operation, the container 12 is filled with processing means approximately up to the height of the level N.

An agitation element 14 is provided at the base of the container 12 which has a plurality of paddles which extend parallel to the base and which are rotatingly driven about a vertical axis of rotation D via a drive 16 which is disposed beneath the container base.

Furthermore, a machine stand 18 is arranged on the base frame 10 and a transverse member 20 is fastened thereto displaceably in the vertical direction, that is along the double arrow X. The vertical movement is in this respect effected via a drive 22 which is not shown in any more detail and which effects, in conjunction with a lift cylinder 24, a raising and a lowering of the transverse member 20. In this respect, the transverse member is raised or lowered along the axis A in the direction of the double arrow X. In the position shown in FIG. 1, the transverse member 20 is in an upper position which corresponds to the loading and unloading position, that is the transverse member 20 can be moved downwardly from the position shown.

At the outer end of the transverse member 20, a chuck 28 is mounted at the lower end of a shaft 27 guided in a shaft 26, said chuck serving for the fastening of a workpiece, for example of a rim F. In this respect, the shaft 27 is fastened to a transmission 30 which is shown in enlarged form in FIG. 2.

As FIG. 2 illustrates, a first drive motor 32, whose axis of rotation extends vertically and which drives a hollow shaft 42, which circulates about a vertical axis of rotation C, via a belt drive 40 arranged in the transverse member 20, is mounted on the transverse member 20 at its right end in FIG. 2. The hollow shaft 42 extends downwardly through the transverse member 20 and further through a two-part turntable 44 whose upper half 46 is screwed to the transverse member 20 and whose lower half 48 is rotatable relative to the upper half 46 via a ball bearing. The hollow shaft 42 is screwed at its lower end to the lower half 48 of the turntable 44 so that the lower half 48 of the turntable 44 rotates together with the hollow shaft 42 on a rotational movement of the hollow shaft 42 about the axis C. A ball bearing 50 is provided in the upper half of the turntable 44 for a frictionless journaling of the hollow shaft 42. A further ball bearing 52 is likewise located between the upper half 46 and the lower half 48 of the turntable 44.

As FIG. 2 further shows, the shaft 26 is fastened via a flange housing 54 eccentrically to the lower half 48 of the turntable 44 so that the shaft 26, the shaft 27 and the chuck 28 fastened thereto circulate along an orbital track when the drive 32 is actuated. In this case, the hollow shaft 42 is set into rotation via the belt drive 40 and rotates the lower half 48 of the turntable 52 accordingly and thus also the flange housing 54 or the shaft 26 fastened thereto with the shaft 27 arranged therein.

To achieve a rotational movement of the chuck 28 about the axis B independently of the orbital movement effected by the drive motor 32, a further drive motor 56 is provided at the outer end of the transverse member 20, said further drive motor driving a vertical shaft 58 which circulates about the axis of rotation C and which extends through the hollow shaft 42. The shaft 58 thus extends along the axis C through the upper half and the lower half of the turntable 44 and is connected at its lower end to a gear 60 which meshes with a further gear 62 which is in communication with the shaft 27 rotatably journaled in the shaft 26. In this manner, the chuck 28 can be rotated about its own central vertical axis B with the help of the second drive motor 56 independently of the orbital movement and independently of a control of the first drive motor 32. The drive 22 thus effects the oscillation movement of the rim F along the axis A in the direction of the double arrow X and the drive motor 32 effects the orbital movement about the axis C, while the drive motor 56 effects the rotational movement of the rim F about its central axis B.

As FIG. 1 shows, the axis of rotation D, which is arranged approximately at the center of the container 12, extends approximately coaxially to the axis of rotation C of the orbital track.

All the drives 16, 22, 32 and 56 and also a drive 70 (FIG. 3) are speed-regulated and reversible in their directions of rotation. All drives are connected to a machine control (not shown) in which the desired working routines can be programmed as desired.

In the apparatus described above, the shaft 26 has an offset of approximately 100 mm to the axis of rotation C. An offset from approximately 80 to approximately 150 mm can be advantageous.

In a method in accordance with the invention, a workpiece, for example, a vehicle wheel rim is dipped into the container filled with processing means, is moved along a closed orbit and is additionally rotated about its own central axis, with the center of the closed orbit being rotated about a stationary vertical axis. It can be advantageous in this respect if the workpiece is moved in a direction of rotation along the closed orbit and is moved about its own central axis in the opposite direction of rotation. The drive 32 can be controlled, for example, such that the workpiece F is moved clockwise along an orbital track within the container 12, while it rotates counter-clockwise about its own axis of symmetry B.

In practice, very good results have been achieved with the following operating parameters for grinding and polishing:

| | Orbital drive 32 | Spindle drive 56 |
|---|---|---|
| Stage 1: Pregrinding | 90-115 r.p.m. | 125-180 r.p.m. |
| Stage 2a: Fine grinding | 90-115 r.p.m. | 125-180 r.p.m. |
| Stage 2b: Fine grinding | 30-45 r.p.m. | 70-125 r.p.m. |
| Polishing | 70-90 r.p.m. | 100-180 r.p.m. |

When work takes place with opposite directions of rotation, the effective drive speed can be calculated from the difference of the orbital speed and the spindle speed.

The orbital drive 32 can preferably be regulated between approximately 30 and 130 r.p.m., while the spindle drive 56 can preferably be regulated from approximately 40 to 200 r.p.m.

Additional oscillation movements in the vertical direction have also proved to be advantageous during the machining.

| | Stroke length | Frequency |
|---|---|---|
| Pregrinding: | 50-150 mm | 30-60 strokes/min |
| Fine grinding a | 50-150 mm | 30-60 strokes/min |
| Fine grinding b | 30-50 mm | 5-10 strokes/min |
| Polishing | 30-150 mm | 10-40 strokes/min |

The maximum stroke length in the vertical direction can amount to approximately 350 mm and can be limited to a maximum frequency of approximately 60 strokes a minute.

FIG. 3 shows a third embodiment of an apparatus for the machining of workpieces which is similar to the embodiment shown in FIGS. 1 and 2 so that the same reference numerals are used for the same or similar components.

In the embodiment shown in FIG. 3, the transverse member 20 can be pivoted clockwise or counter-clockwise about the vertical axis of rotation A in the direction of the vertical arrow R with the help of a third drive motor 70, i.e. the central axis C of the orbital track can be pivoted about the stationary axis of rotation A. In this case, the container 12 is made in ring shape and instead of the member 20 a carousel can also be provided at which a plurality of chucks are rotatably journaled in the same way, as is shown in FIGS. 1 and 2.

In the embodiment shown in FIG. 3, in addition to the oscillation movement in the direction of the double arrow X along the axis A, a first rotational movement is possible about the axis A, a second rotational movement about the axis C and a third rotational movement about the axis B which forms the central axis of the chuck 28 for the vehicle wheel rim F.

In all the embodiments shown, a plurality of chucks can be provided in parallel and eccentrically about the rotating axis of rotation C. For example, the chucks can each be rotated about their own central axes with the help of a planetary transmission and with the help of a common drive motor. Alternatively, a separate drive motor can be provided for each chuck to be able to set the speed of the respective workpiece individually for its own rotation.

### REFERENCE NUMERAL LIST

10 base frame
12 container
14 agitation element
16 drive
18 machine stand
20 transverse member
22 drive
24 lift cylinder
26 shaft
27 shaft
28 chuck
30 transmission
32 second drive motor
40 belt drive
42 hollow shaft
44 turntable
46 upper half
48 lower half
50 ball bearing
52 ball bearing
54 flange housing
56 first drive motor
58 shaft
60, 62 gear
70 third drive motor
A axis
B, C, D axis of rotation
F rim
N machining body level
R direction of rotation
x stroke direction

1. A method for the machining of at least one rotationally symmetrical workpiece (F), for example of a vehicle wheel rim, wherein the workpiece (F) is dipped into a container filled with processing means and is moved relative to the container, with the workpiece simultaneously:
being rotated about its own central vertical axis (B) by a first drive motor (56);
having its central axis (B) moved by a second drive motor (32) along a closed orbit about a rotating vertical axis (C) in the container, wherein the rotating vertical axis (C) is rotated about a stationary vertical axis of rotation (A) by a third drive motor (70).

2. A method in accordance with claim 1, characterized in that a plurality of workpieces (F) are dipped into the container (12) and are moved relative to the container, with all the workpieces being rotated about their own central vertical axes (B), about the rotating vertical axis (C) and about the stationary vertical axis of rotation (A).

3. A method in accordance with claim 1, characterized in that the workpiece (F) is moved in a direction of rotation along the closed orbit and is moved about its own central axis (B) in the opposite direction of rotation.

4. A method in accordance with claim 1, characterized in that the speed of the first drive motor (56) is regulated independently of the speed of the second drive motor (32) and/or of the third drive motor (70).

5. A method in accordance with claim 1, characterized in that the workpiece is moved up and down in the vertical direction (X) in the container.

6. An apparatus for the machining of workpieces, comprising
a container (12) for processing means;
at least one chuck (28) for the fastening of at least one workpiece (F);
a rotation device (26, 27, 56, 58, 60, 62) which sets the chuck (28) into rotation about its own central axis (B); and
an orbital drive (32, 40, 42, 44, 54) which moves the chuck (28) along a closed orbit about a vertical axis (C),
characterized in that the rotation device and the orbital drive each have their own independently controllable drive motor (32, 56).

7. An apparatus in accordance with claim 6, characterized in that the two drive motors (32, 56) are mounted on a component (20) which is stationary or which can be oscillated in the vertical direction by an oscillation device (22).

8. An apparatus in accordance with claim 6, characterized in that the orbital drive has a component (44) which is rotatably driven by a drive motor (32) and to which the chuck or chucks (28) are fastened eccentrically and rotatably.

9. An apparatus in accordance with claim 6, characterized in that the rotation device has a shaft (58) which is rotatably driven by the other drive motor (56), which extends through the component (44) and which is in rotational communication with the chuck (28).

10. An apparatus in accordance with claim 6, characterized in that the two drive motors (32, 56) are mounted on a component (20) which is rotatable about a stationary vertical axis (A).

11. An apparatus in accordance with claim 6, characterized in that the rotation device (26, 27, 56, 58, 60, 62) has a plurality of chucks (28) which can be set into rotation about their own central axes (B) via a common transmission or via a respective separate drive.

12. An apparatus in accordance with claim 6, characterized in that all the axes of rotation (A, B, C) extend in parallel.

13. An apparatus in accordance with claim 6, characterized in that none of the drive motors (56, 32) is exposed to a rotational movement or to an orbital movement.

14. An apparatus in accordance with claim 6, characterized in that a third drive motor (70) is provided which rotates the vertical axis (C) about a stationary vertical axis of rotation (A).

15. An apparatus in accordance with claim 14, characterized in that all three motors are controllable independently of one another.
